(19) United States
(12) Patent Application Publication
(10) Pub. No.: US 2009/0048402 A1
(43) Pub. Date: Feb. 19, 2009

(54) Preparing multimodal polyethylene having controlled long chain branching distribution

(76) Inventors: Michael W. Lynch, West Chester, OH (US); Mark K. Reinking, Mason, OH (US)

Correspondence Address: LyondellBasell Industries, 3801 WEST CHESTER PIKE, NEWTOWN SQUARE, PA, 19073, US

(21) Appl. No.: 11/894,016

(22) Filed: Aug. 17, 2007

(51) Int. Cl. C08L 23/06

(52) U.S. Cl. 525/240

(57) ABSTRACT

A process to prepare a multimodal polyethylene with controlled LCB distribution is disclosed. In the first stage, ethylene is polymerized in the presence of a Ziegler catalyst that results in a homopolyethylene component having a higher LCB concentration. In the second stage, ethylene is copolymerized with a 1-olefin in the presence of the Ziegler catalyst and a lower concentration of hydrogen resulting in a copolymer component with a lower LCB concentration. The homopolyethylene component and the copolymer component are combined to form a novel multimodal polyethylene.

### FIELD OF THE INVENTION

This invention relates to a multimodal polyethylene which has controlled long chain branching distribution and to a process of making the multimodal polyethylene.

### BACKGROUND OF THE INVENTION

Enhancing the level of long-chain branching (LCB) in a polyethylene resin is desirable because LCB affects the rheological properties and therefore the processability of the resin. Moreover, the level of LCB can affect the polyethylene's mechanical properties such as the environmental stress crack resistance (ESCR) of a polyethylene article.

Methods for enhancing the LCB level of polyethylene are known. One method is to enhance the level of LCB during the preparation of the initial polyethylene resin. For example, U.S. Pat. No. 4,851,489 discloses a co-catalyst that increases the level of LCB. The co-catalyst has a general structure of R₁R₂AlRₚ, where R₁ and R₂ are C₁ to C₁₈ hydrocarbyl groups, and Rₚ is a monovalent polymeric hydrocarbyl group having a long chain branching frequency of about 0.0005 to about 0.005 per unit molecular weight. U.S. Pat. No. 7,112,643 discloses a method of treating a calcined alumina support with a sulfating agent to decrease the level of LCB in the resulting polyethylenes. Low levels of long chain branching are indicated by the narrow rheological breadth. Rheological breadth refers to the frequency dependence of the viscosity of the polymer. The rheological breadth is a function of the relaxation time distribution of a polymer resin, which in turn is a function of the resin molecular structure or architecture. Thus, a narrow rheological dispersity, a short relaxation time, and a low zero-shear viscosity all indicate a lower level of LCB.

Another method to enhance the level of LCB is to modify the initial polyethylene resin. U.S. Pat. No. 5,530,072 discloses mixing the polyethylene resin with peroxide and an antioxidant in the extruder. The free radicals that are generated react with the polyethylene resin to abstract hydrogen from the polyethylene backbone, resulting in an increase in the level of LCB when the chain extension or branching exceeds the chain scission. The antioxidant is used to protect the polyethylene from excessive oxidative degradation.

New methods of enhancing the levels of LCB of polyethylene are needed. Ideally, the method can be used to control the distribution of the LCB in a multimodal polyethylene.

### SUMMARY OF THE INVENTION

The invention is a process for controlling the level and distribution of LCB of a multimodal polyethylene resin. The process comprises at least two stages: one stage comprises homopolymerizing ethylene and a second stage which comprises copolymerizing ethylene and one or more 1-olefins. Both stages are carried out in the presence of a specific subset of Ziegler catalysts and co-catalysts which are capable of producing a homopolyethylene component having a higher LCB concentration in the first stage and an ethylene-1-olefin copolymer component having a lower LCB concentration in the second stage. Suitable Ziegler catalyst includes those which comprises (i) a transition metal compound selected from the group consisting of M(OR′)ₐX₄₋ₐ and MOX₃, in which M is a transition metal selected from the group consisting of titanium, vanadium, and zirconium, R is a C₁ to C₁₉ alkyl group, X is a halogen, and a is zero or an integer less than 4; (ii) a magnesium-aluminum complex, (MgR₂)ₘ(AlR₃)ₙ, in which R can be the same or different and selected from C₁ to C₁₂ alkyl groups, and the ratio of m/n is within the range of about 0.5 to about 10; and (iii) a silica or alumina support. The co-catalyst is a trialkyl aluminum compound.

We have surprisingly discovered that the above-specified catalyst and co-catalyst combination produces a higher LCB concentration in homopolyethylene than in an ethylene-1-olefin copolymer. The higher LCB concentration is indicated by a broader rheological dispersity (R_{D}) and higher melt elasticity (ER).

Thus, the process of the invention produces a unique multimodal polyethylene. The multimodal polyethylene comprises a homopolyethylene component and an ethylene-1-olefin copolymer component, wherein the homopolyethylene component has a higher LCB concentration than the copolymer component.

The first stage and the second stage of the process can be performed with the two reactors operating in parallel. The polymers from these two stages can be combined in a third reactor or in a mixer. The first stage and the second stage can also be performed with the two reactors operating in series. The first stage is performed in a first reactor to form a homopolyethylene component. The homopolyethylene component is transferred to a second reactor wherein the second stage of the process is performed to form an ethylene-1-olefin copolymer component which is mixed therein with the homopolyethylene component from the first stage. The first stage and the second stage can also be performed in the same reactor sequentially in a batch process.

### DETAILED DESCRIPTION OF THE INVENTION

The process of the invention comprises two stages. Both stages are carried out in the presence of a specific subset of Ziegler catalysts and co-catalysts. The Ziegler catalysts and co-catalysts are capable of producing a homopolyethylene component having a higher long chain branching (LCB) concentration in the first stage and an ethylene-1-olefin copolymer component having a lower LCB concentration in the second stage.

Suitable Ziegler catalyst comprises a transition metal compound. The transition metal compound are selected from the group consisting of M(OR′)ₐX₄₋ₐ and MOX₃, in which M is a transition metal selected from the group consisting of titanium, vanadium, and zirconium, R′ is a C₁ to C₁₉ alkyl group, X is a halogen, and a is zero or an integer less than 4. Examples of suitable transition metal compounds include TiCl₄, Ti(OR′)Cl₃, Ti(OR′)₂Cl₂, Ti(OR′)₃Cl, VOCl₃, VCl₄, the like, and mixtures thereof. The transition metal compounds are known in the art, e.g., U.S. Pat. No. 4,263,171.

Suitable Ziegler catalyst comprises a magnesium-aluminum complex. Suitable magnesium-aluminum complex include those which have the general structure of (MgR₂)ₘ(AlR₃)ₙ, in which R can be the same or different and selected from C₁ to C₁₂ alkyl groups, and the ratio of m/n is within the range of about 0.5 to about 10. The magnesium-aluminum complex is known in the art, e.g., U.S. Pat. Nos. 4,004,071 and 4,263,171.

Suitable catalyst also comprises a silica or alumina support. Preferably, the support has a surface area in the range of about 10 to about 700 m²/g, a pore volume in the range of about 0.1 to about 4.0 mL/g, an average particle size in the range of about 5 to about 500 μm, and an average pore diameter in the range of about 5 to about 1000 A. They are preferably modified by heat treatment, chemical modification, or both. For heat treatment, the support is preferably heated at a temperature from about 50° C. to about 1000° C. More preferably, the temperature is from about 50° C. to about 600° C.

In the first stage, the hydrogen concentration is preferably within the range of about 0.1 mol % to about 10 mol %, more preferably about 0.5 mol % to about 5 mol %, and most preferably about 1 mol % to about 3 mol % of ethylene.

The first stage can be performed in slurry or gas phase. Preferably the temperature for slurry processes is within the range of about 30° C. to about 110° C., more preferably about 40° C. to about 100° C., and most preferably about 50° C. to about 95° C.

Preferably the temperature for gas phase processes is within the range of about 60° C. to about 120° C., more preferably about 70° C. to about 110° C., and most preferably about 75° C. to about 100° C.

Preferably the homopolyethylene component prepared in the first stage has a number average molecular weight (Mn) within the range of about 5,000 to about 800,000, more preferably of about 15,000 to about 500,000, and most preferably of about 20,000 to about 500,000. Preferably, the homoployethylene component has a weight average molecular weight (Mw) within the range of about 15,000 to about 2,500,000, more preferably of about 50,000 to about 1,500,000, and most preferably of about 75,000 to about 1,500,000.

Depending on the desired multimodal polyethylene design, the preferable melt index (MI₂) of the homopolyethylene prepared in the first stage is within the range of about 0.1 g/10 min to about 500 g/10 min, more preferably about 0.5 g/10 min to about 200 g/10 min, and most preferably about 1 g/10 min to about 100 g/10 min.

Preferably the homopolyethylene component prepared in the first stage has a concentration of LCB per 1000 carbon atoms within the range of about 0.01 to about 2.0, more preferably of about 0.05 to about 1.5, and most preferably of about 0.1 to about 1.0. Long chain branching can be measured by NMR, 3D-GPC, and rheology. While NMR directly measures the number of branches, it cannot differentiate between branches which are six carbons or longer. 3D-GPC with intrinsic viscosity and light scattering detection can account for all branches that substantially increase mass at a given radius of gyration. Rheological dispersity (R_{D}) is particularly suitable for detecting low level of long chain branches. The R_{D} value can be determined according to the method disclosed by M. Shida and L. V. Cancio in Polymer Engineering and Science, Vol. 11, pages 124-128 (1971). A low value of R_{D} indicates a low level of LCB and a narrow molecular weight distribution (MWD). Preferably the R_{D} of the homopolyethylene component prepared in the first stage is within the range of about 1 to about 12, more preferably about 3 to about 10, and most preferably about 4 to about 8.

The melt elasticity (ER) also provides a means of approximating the level of LCB and the polydispersity of a polymer. A low ER value indicates a narrow molecular weight distribution and lower levels of LCB. ER is derived from Theological data on the polymer melts, see the article by Shroff, et al., entitled “New Measures of Polydispersity from Rheological Data on Polymer Melts,” J. Applied Polymer Science, Vol. 57, pp. 1605-1626 (1995) and U.S. Pat. No. 5,534,472.

ER values are calculated from rheological data generated by measuring dynamic rheology in the frequency sweep mode, as described in ASTM 4440-95a. A Rheometrics ARES rheometer was operated at 150° C., in the parallel plate mode in a nitrogen environment. The gap in the parallel plate geometry was about 1.2 mm to about 1.4 mm and the strain amplitude was about 10% to 20%. The range of frequencies was about 0.0251 rad/sec. to about 398.1 rad/sec.

Preferably the homopolyethylene component made in the first stage has an ER within the range of about 0.3 to about 2.

In the second stage, the hydrogen concentration is preferably lower than in the first stage so that the copolymer component made in the second stage has a higher molecular weight than the homopolyethylene component made in the first stage. Preferably, the hydrogen concentration in the second stage is less than 4 mol %, more preferably within the range of about 0.01 mol % to about 3 mol %, and most preferably within the range of about 0.1 mol % to about 2 mol %.

The second stage is preferably performed at a temperature which is lower than the first stage. Lower polymerization temperature gives the copolymer component produced in the second stage a lower LCB and higher molecular weight. Preferably the temperature for the second stage is within the range of 30° C. to 110° C.

The second stage can be performed in slurry and gas phase. The second stage can be performed in slurry while the first stage performed in slurry or in gas phase. The second phase is preferably performed in slurry if the first stage is performed in slurry.

Preferably, the copolymer component prepared in the second stage has a R_{D} within the range of about 0.1 to about 8, more preferably of about 0.5 to about 6, and most preferably of about 2 to about 4.

Preferably, the copolymer component prepared in the second stage has a number average molecular weight (Mn) within the range of about 5,000 to about 1,000,000, more preferably of about 15,000 to about 800,000, and most preferably of about 25,000 to about 500,000. Preferably the copolymer component has a weight average molecular weight (Mw) within the range of about 15,000 to about 3,000,000, more preferably of about 50,000 to about 2,500,000, and most preferably of about 50,000 to about 2,500,000.

Preferably the melt index (MI₂) of the copolymer component prepared in the second stage is within the range of about 0.001 g/10 min to about 12 g/10 min, more preferably of about 0.1 g/10 min to about 10 g/10 min, and particularly preferred of about 0.5 g/10 min to about 8 g/10 min.

Suitable 1-olefins for the use in the second stage include C₃ to C₂₀ 1-olefins. Examples of suitable 1-olefins include propylene, 1-butene, 1-hexene, 1-octene, 4-methyl-1-pentene, the like and mixtures thereof. 1-Butene, 1-hexene, and mixtures thereof are particularly preferred.

The ratio of ethylene to 1-olefin depends on the desired density and the 1-olefin used. For example, a molar ratio of 1-butene/ethylene to produce a copolymer component having a density of about 0.920 g/cm³ is about 2.5/97.5. Increasing the amount of 1-olefin decreases the density of the copolymer component.

The first stage and the second stage of the process can be performed in the same reactor. For instance, a first stage is performed by feeding a reactor with the catalyst, co-catalyst, ethylene, hydrogen and optionally solvent to form a homopolyethylene component and thereafter a second stage is performed by feeding the same reactor with ethylene and 1-olefin to form a copolymer component in the presence of the homopolyethylene component in a batch mode. The homopolyethylene component and the copolymer component are thus mixed in situ to form a multimodal polyethylene product. If it is desirable to perform the second stage with a reduced hydrogen concentration, the reaction mixture from the first stage can be vented to remove hydrogen from the first stage before the second stage is performed. Alternatively, the second stage can be performed prior to the first stage in the reactor. By this alternative way, a second stage is performed by feeding a reactor with the catalyst, co-catalyst, ethylene, 1-olefin, optionally hydrogen and optionally solvent to form a copolymer component; any unreacted 1-olefin monomer is removed from the reaction mixture, and a first stage is then performed to form a homopolyethylene by feeding the reactor with ethylene and optionally hydrogen.

The first stage and the second stage can be performed in parallel reactors. A first stage is performed in a first reactor to produce a homopolyethylene component and a second stage is performed in a second reactor to produce a copolymer component. The homopolyethylene component and the copolymer component are mixed in a third reactor or in a mixer to form a multimodal polyethylene.

The first stage and the second stage can also be performed in sequential reactors. For instance, a first stage is performed in a first reactor and the homopolyethylene component produced therein is transferred to a second reactor in which a second stage is performed to produce a copolymer component. The homopolyethylene component and the copolymer component are mixed in situ to form a multimodal polyethylene product.

As indicated above, there are a variety of ways to conduct the process of the invention. The first stage and the second stage of the process can be performed in different order and in one or more reactors.

The invention also includes a novel multimodal polyethylene. The multimodal polyethylene of the invention comprises a homopolyethylene component and an ethylene-1-olefin copolymer component, wherein the homopolyethylene component has a higher concentration of long chain branching (LCB) than the copolymer component.

Preferably, the homopolyethylene component has a R_{D} within the range of about 2 to about 12, more preferably of about 3 to about 10, and most preferably about 4 to about 8. Preferably, the homopolyethylene component has a density of greater than 0.955 g/cm³, more preferably of greater than 0.96 g/cm³. Preferably, the homopolyethylene component has an ER within the range of about 0.3 to about 2. Preferably, the homopolyethylene component has an MI₂ within the range of about 0.1 g/10 min to about 500 g/10 min, more preferably of about 0.5 g/10 min to about 200 g/10 min, and most preferably of about 1 g/10 min to about 100 g/10 min.

Preferably, the copolymer component prepared in the second stage has a R_{D} within the range of about 0.1 to about 8, more preferably of about 0.5 to about 6, and most preferably of about 2 to about 4. Preferably, the copolymer component has a density of less than or equal to 0.96 g/cm³, more preferably within the range of about 0.90 to 0.955 g/cm³, and most preferably within the range of about 0.925 to about 0.945 g/cm³. Preferably, the copolymer component has an ER within the range of about 0.1 to about 1.2. Preferably, the copolymer component has an MI₂ within the range of about 0.001 g/10 min to about 5 g/10 min, more preferably of about 0.1 g/10 min to about 5 g/10 min, and particularly preferred of about 0.5 g/10 min to about 5 g/10 min.

Preferably, the multimodal polyethylene of the invention has a weight ratio of homopolyethylene component/copolymer component within the range of about 10/90 to about 90/10, more preferably of about 20/80 to about 80/20, and most preferably of about 30/70 to about 70/30. Additives known to those with skill in the art (e.g. antioxidants, lubricants, stabilizers) can be added during the first and second stages in an amount designed to produce the intended effect. The total amount of additives will generally be within the range of about 0.01 wt % to about 5.0 wt % of the total weight of multimodal polyethylene.

The multimodal polyethylene of the invention is useful for making films, grocery sacks, institutional and consumer can liners, merchandise bags, shipping sacks, food packaging films, multi-wall bag liners, produce bags, deli wrap, stretch wrap and shrink wrap. The films prepared with the multimodal polyethylene of the invention can also be used to prepare multilayer films. The multilayer films can be machine-oriented uniaxially or biaxially. The resins can also be used for injection or blow-molding processes to prepare pipes, molded articles, packaging, pails, crates, detergent bottles or containers.

The following examples merely illustrate the invention. Those skilled in the art will recognize many variations that are within the spirit of the invention and scope of the claims.

### EXAMPLE 1

### Catalyst Preparation

The general procedure of U.S. Pat. No. 4,263,171, Example 1, is followed to prepare the catalyst of Example 1. A sufficient quantity of grade 952 silica, Davison Chemical Company, is calcined (600° C.) in a fluidized bed with a nitrogen flow (5 h). The calcined silica (2.2 kg, 16.1 wt. %) is added to a vessel and stirred at room temperature in a nitrogen environment (1 h) before cooling the silica (0° C.). While stirring the silica under a nitrogen environment, a heptane solution (13.8 L, 9.4 kg, 69.0 wt %) that contains an organomagnesium-aluminum complex, {(C₄H₉)₂Mg}_{6.5}{(C₂H₅)₃Al}: dibutylmagnesium (0.51 M, 972.9 g, 7.1 wt %), triethylaluminum (0.078 M, 65.66 g, 0.5 wt %)] is added and stirred for 0.5 h. Titanium tetrachloride (0.75 L, 6.7 mmol, 7.3 wt %) is then added and stirred (0.5 h). The mixture is heated to 90° C. and dried under continuous nitrogen flow until a free-flowing dark-brown powder is produced.

### EXAMPLES 2-7

### First Stages: Homopolymerization of Ethylene

A slurry loop reactor is purged with nitrogen before adding isobutane and sealing the reactor. During the polymerization, sufficient amounts of the catalyst prepared in Example 1, ethylene, hydrogen and isobutane are continuously added to the reactor. Effluent is periodically discharged from the reactor and passed to a flash chamber where the homopolyethylene component is recovered.

For Examples 2 and 3, the reaction temperature is 79.4° C.; the hydrogen concentrations (mole % based on total moles of hydrogen and ethylene charged to the reactor) are 1.51 and 1.72, respectively; the melt indices (MI₂) of the homopolyethylene components are 0.4 g/10 min and 0.9 g/10 min, respectively; and the rheological dispersities (R_{D}) of the homopolyethylene components are 5.6 and 5.9, respectively.

For Examples 4 to 7, the temperature is 101.7° C.; the hydrogen concentrations (mole %) are 0.81, 0.76, 0.79, and 0.71, respectively; the MI₂ of the homopolyethylene components are 0.9, 1.2, 1.2, and 0.7, respectively; and the R_{D} of the homopolyethylene components are 4.4, 4.7, 4.2, and 4.7, respectively.

The process conditions of the first stages and properties of resulted homopolyethylene components are summarized in Table 1.

### EXAMPLES 8-13

### Second Stages: Copolymerization of Ethylene and 1-hexene

Catalyst A is used. For Examples 8 and 9, the temperature is 79.4° C., the hydrogen concentrations (mole % based on the total moles of hydrogen, ethylene and 1-hexene charged to the reactor) are 0.8 and 0.9, respectively; the MI₂ values of the copolymer components are 0.21 g/10 min and 0.29 g/10 min, respectively; and the R_{D} values of the copolymer components are 4.6 and 5.0, respectively.

For Examples 10 to 13, the temperature is 87.8° C.; the hydrogen concentrations (mole %) are 0.71, 0.7, 0.56 and 0.47, respectively; the MI₂ values of the copolymer components are 0.26, 0.12, 0.28, and 0.2, respectively; and the R_{D} values of the copolymer components are 4.6, 4.8, 4.8 and 5.1, respectively.

Note that the copolymer components have significantly lower R_{D} values than the homopolyethylene components made by the same catalyst.

The process conditions of the first stages and the properties of the resulted copolymer components are summarized in Table 1.

Each or any combination of the homopolyethylene components of Examples 2-7 can be mixed with each or any combination of the copolymer components of Examples 8-13 in a desirable ratio to form multimodal polyethylene products of the invention.

TABLE 1
The First and Second Stages and Resulted Homopolyethylene
and Copolymers Components

| | | H₂ | 1-Hexene | MI₂* | |
|---|---|---|---|---|---|
| Ex. No. | Temp. (° C.) | (mol %) | (mol %) | (dg/min) | R_{D} |
| 2 | 79.4 | 1.51 | — | 0.4 | 5.6 |
| 3 | 79.4 | 1.72 | — | 0.9 | 5.9 |
| 4 | 101.7 | 0.81 | — | 0.9 | 4.4 |
| 5 | 101.7 | 0.76 | — | 1.2 | 4.7 |
| 6 | 101.7 | 0.79 | — | 1.2 | 4.2 |
| 7 | 101.7 | 0.71 | — | 0.7 | 4.7 |
| 8 | 79.4 | 0.8 | 1.2 | 0.21 | 4.6 |
| 9 | 79.4 | 0.9 | 1.2 | 0.29 | 5.0 |
| 10 | 87.2 | 0.71 | 0.95 | 0.26 | 4.6 |
| 11 | 87.8 | 0.7 | 2.1 | 0.12 | 4.8 |
| 12 | 87.8 | 0.56 | 3.4 | 0.28 | 4.8 |
| 13 | 87.8 | 0.47 | 2.4 | 0.2 | 5.1 |

*MI₂ is measured in accordance with ASTM D 1238-01, at 190° C. under 21.6 kg pressure.

We claim:

1. A process of preparing a multimodal polyethylene, which comprises:
(a) a first stage of homopolymerizing ethylene with a Ziegler catalyst and a co-catalyst to form a homopolyethylene component having a rheological dispersity (R_{D}) within the range of about 1 to about 12;
(b) a second stage of copolymerizing ethylene and at least one C₃ to C₁₀ 1-olefin with the catalyst and the co-catalyst to form a copolymer component having a R_{D} within the range of about 0.1 to about 8; and
(c) mixing the homopolyethylene component and the copolymer component to form the multimodal polyethylene.

2. The process of claim 1 wherein the catalyst comprises: (i) the transition metal compound selected from the group consisting of M(OR′)ₐX₄₋ₐ and MOX₃, in which M is a transition metal selected from the group consisting of titanium, vanadium, and zirconium, R′ is a C₁ to C₁₉ alkyl group, X is a halogen, and a is zero or an integer less than 4; (ii) a magnesium-aluminum complex, (MgR₂)ₘ(AlR₃)ₙ, in which R is a C₁ to C₁₂ alkyl group, and m/n is 0.5 to 10; and (iii) a silica or alumina; and wherein the co-catalyst is a trialkyl aluminum compound.

3. The process of claim 1 wherein the transition metal compound is selected from the group consisting TiCl₄, Ti(OR′)Cl₃, Ti(OR′)₂Cl₂, Ti(OR′)₃Cl, VOCl₃, VCl₄, and mixture thereof.

4. The process of claim 1 wherein the transition metal compound is TiCl₄.

5. The process of claim 1 wherein the magnesium-aluminum complex is {(C₄H₉)₂Mg}_{6.5}{(C₂H₅)₃Al}.

6. The process of claim 1 wherein the first stage is performed at a higher temperature than the second stage.

7. The process of claim 1 wherein the first stage is performed at a higher hydrogen concentration than the second stage.

8. The process of claim 1 wherein the homopolyethylene component prepared in the first stage has a higher melt index MI₂ than the copolymer component prepared in the second stage.

9. The process of claim 1 wherein the first stage and the second stage are performed in two parallel reactors.

10. The process of claim 1 wherein the first stage and the second stage are performed in two sequential reactors.

11. A multimodal polyethylene which comprises
(a) a homopolyethylene component having
(i) a rheological dispersity (R_{D}) within the range of about 2 to about 12;
(ii) a density of greater than 0.96 g/cm³;
(iii) a melt elasticity (ER) within the range of about 0.3 to about 2; and
(iv) a melt index (MI₂) within the range of about 0.1 g/10 min to 500 g/10 min; and
(b) an ethylene-1-olefin copolymer component having
(i) a R_{D} within the range of about 0.1 to about 8;
(ii) a density of less than or equal to 0.955 g/cm³;
(iii) an ER within the range of about 0.1 to about 1.2; and
(iv) an MI₂ within the range of about 0.001 g/10 min to 5 g/10 min.

12. The multimodal polyethylene of claim 11 wherein the homopolyethylene component has a R_{D} within the range of about 3 to about 10, and the copolymer component has a R_{D} within the range about 0.5 to about 6.

13. The multimodal polyethylene of claim 11 wherein the homopolyethylene component has a R_{D} within the range of about 4 to about 8, and the copolymer component has a R_{D} within the range about 2 to about 4.

14. The multimodal polyethylene of claim 11 wherein the homopolyethylene component has a density greater than or equal to 0.96 g/cm³, and the copolymer component has a density within the range about 0.9 g/cm³ to about 0.955 g/cm³.

15. The multimodal polyethylene of claim 11 wherein the homopolyethylene component has an MI₂ within the range of 0.5 g/10 min to about 200 g/10 min, and the copolymer component has an MI₂ within the range about 0.1 g/10 min to about 5 g/10 min.

16. The multimodal polyethylene of claim 11 wherein the 1-olefin is a C₃-C₁₀ olefin.

17. The multimodal polyethylene of claim 11 wherein the 1-olefin is selected from the group consisting of propylene, 1-butene, 1-hexene, 1-octene, 4-methyl-1-pentene, and mixtures thereof.

18. The multimodal polyethylene of claim 11 wherein the 1-olefin is 1-hexene.

19. The multimodal polyethylene of claim 11 having a weight ratio of homopolyethylene component/copolymer component within the range of about 10/90 to about 90/10.

20. The multimodal polyethylene of claim 11 having a weight ratio of homopolyethylene component/copolymer component within the range of about 20/80 to about 80/20.
